(19) United States
(12) Patent Application Publication
(10) Pub. No.: US 2020/0290196 A1
(43) Pub. Date: Sep. 17, 2020

(54) ROBOT SYSTEM, DEVICE, AND METHOD FOR APPLYING A PROCESS FORCE TO AN OBJECT

(71) Applicant: FRANKA EMIKA GmbH, Münichen (DE)

(72) Inventors: Niklas Böhme, München (DE); Sebastian Getz, München (DE)

(73) Assignee: FRANKA EMIKA GmbH, Münichen (DE)

(21) Appl. No.: 16/756,823

(22) PCT Filed: Oct. 18, 2018
(86) PCT No.: PCT/EP2018/078536

§ 371 Date: May 28, 2020

(30) Foreign Application Priority Data
Oct. 18, 2017 (DE) 102017124356.9

(51) Int. Cl. B25J 3/00; B25J 9/16; B25J 13/08; G05B 19/423

(52) U.S. Cl. CPC B25J 3/00; B25J 9/1633; G05B 2219/39319; G05B 19/423; B25J 13/082

(57) ABSTRACT

The present invention relates to a robot system, a device, and a method for applying a process force (F_{P}) to an object within the scope of a task to be performed by a robot in relation to the object, the robot system allowing an amplification of the input force (F_{EIN}) input by a user with simultaneous feedback control, so as to thus enable a sensitive control of tasks.

The present invention relates to a robot system, a device and a method for applying a process force to an object in the context of an activity or task to be performed by a robot in relation to the object.

By means of robots, in particular robots of lightweight construction, different tasks can be performed. The spectrum ranges from simple pick & place activities, processing of workpieces and lifting or carrying objects to interactions with the human body, such as in surgery.

The robot, which usually moves relative to the object that the robot is processing or handling with its multi-axis manipulator or end effector in the course of processing or handling, always applies a process force or process force sequence the values of which depend on the type of activity or operation.

Depending on the configuration, robots of lightweight construction are designed to carry only a limited load or to apply only a limited process force. This limits the possible applications with regard to these parameters. However, under certain circumstances it may be necessary or desirable to be able to apply higher process forces to an object or item when using such robots.

Furthermore, there are activities, such as in the field of medicine, physiotherapy, geriatrics or in general in connection with humans who, due to their age or disability, are only partially able to lift loads or perform manual activities that require a certain amount of force.

On the basis thereof, the objective of the present invention is to provide a robot system or a device and a method for exerting or applying a process force with respect to an object, in which a robot is used which supports the activities or tasks for which the process force is intended, whereby these activities should always remain controllable by an user.

This objective is solved with a robot system according to claim 1, with a device for applying a process force to an object according to claim 8, and with a corresponding method according to claim 21.

In a first aspect, the invention relates to a robot system comprising a multi-axis manipulator for applying a process force to an object in relation to task by means of which the manipulator interacts with the object, wherein the manipulator is designed, upon contact with the object, to
detect an input force directly applied to the manipulator by a contact of a user,
amplify the input force depending on a defined conversion factor to a desired value of the process force in relation to said task,
detect a counterforce that is generated when the manipulator comes into contact with the object, and
transmit this counterforce to the user depending on a defined conversion factor.

In this way, a user directly interacting with the manipulator of the robot system, by actually touching it to guide the manipulator and to apply the input force, is able to control, through the detection of the counterforce coming from the manipulator, both his way to move the manipulator during the execution of the task and, above all, his control of the input force. The feedback control thus obtained allows the user to operate the manipulator of the robot system sensitively with at the same time minimum effort.

The robot system according to the invention amplifies the force entered or applied by the user according to predetermined conversion factors. Consequently, the input force is always determined by the user while the manipulator performs the desired action with respect to the object.

In a special embodiment, the manipulator can also be designed to change the conversion factor for the amplification to the value of the process force during the performance of the activity. In this way, a user can actively increase or decrease the resulting process force as required while the manipulator is performing the activity, which is particularly useful in physiotherapeutic activities or in manufacturing activities, when unexpected resistance arises that increases the counterforce or requires a higher process force, such as when drilling holes or screwing in screws.

Preferably, the conversion factor in relation to the counterforce should correspond to the reciprocal of the conversion factor in relation to the process force, which provides the user with a feedback control that is more subjectively understandable for him.

The manipulator may have at least one means of detecting the input force applied by the user, for example in the form of commonly known piezoelectric pressure sensors or strain gauges embedded in a corresponding structure placed on the manipulator at a suitable location.

Furthermore, the manipulator may have at least one means of transmitting the counterforce to the user. As the manipulator, when in contact with the object and according to the application of the process force, inherently absorbs a counterforce in the sense of the then prevailing force equilibrium, depending on the conversion factor, this counterforce must be transmitted to the user via the predetermined conversion factor. The means is designed to communicate this to the user, preferably in a haptic way, by means of a corresponding, then reduced, counterpressure.

The manipulator or articulated arm of the robot system is preferably designed to be compliance-controlled, in particular impedance-, admittance- and/or torque-controlled, and has an end effector at its distal end on which the means for feedback control and, if necessary, also the means for inputting the input force can be arranged.

In a second aspect, the invention relates to a device for applying a process force to an object, with
at least one input device adapted to determine an input force with respect to the object, the input device comprising at least one means for detecting the input force; and
a robot system with a manipulator, which is designed to apply a process force to the object when it comes into contact with the object and, depending on a defined conversion factor, to amplify the input force to the value of the process force during application;

wherein the manipulator is further configured to detect a counterforce which is produced when the manipulator contacts the object, and wherein the input device is configured to map this counterforce.

The manipulator of the robot system is preferably a multi-axis arm of a lightweight robot, whereby one or more movement axes can be force-controlled or force-regulated, which is made possible by appropriate sensor technology. This enables the manipulator to exhibit sensitive behavior. For example, a sensitive manipulator can feel a surface to be processed by detecting the counterforce acting on the manipulator when touching the surface. Furthermore, such a sensitive or compliant manipulator can move along an unknown surface with force guidance, whereby the manipulator or its end effector remains in contact with the surface. The contact force acting between the end effector of the manipulator and the object can be detected by the manipulator's sensors and evaluated by the manipulator's control system to guide the manipulator sensitively or compliantly along the object.

According to the invention, the input device to be used, irrespective of its actual structural configuration, is configured to be able to detect forces, e.g. by means of appropriately designed force measuring sensors, on the one hand, and to return the counterforces detected by the manipulator via feedback control, on the other hand, e.g. either by actively generating these forces, if necessary with a corresponding reducing conversion factor, or by executing a counter movement which can then be directly transmitted from the manipulator to the input device.

Due to the fact that the counterforces are absorbed by the manipulator, an user of the input device can quasi “feel” these opposing or counterforces, thus enabling a sensitive, user-defined control of the device.

At the same time, the device according to the invention enables a defined force amplification to a required process force in order to perform the desired activities or operations. The conversion factor provided for this purpose is determined in relation to the activity and can also be actively changed by the user during the activity.

For this purpose, the device or the robot system is equipped with a control system which, on the one hand, enables a corresponding force/compliance control of the manipulator and, on the other hand, takes the corresponding conversion factors into account. The control system can also be connected to other input devices, such as voice input, which allows the user to actively change the force curve in relation to the process force to be applied during the execution of the task by entering the appropriate commands in real time.

The input device may be designed and constructed separately from the manipulator in order to determine the input force only when there is actual physical contact with the manipulator.

In a particular design of the device, the input device is a rigid structure, such as an exoskeletal glove or thimble, which a user may wear.

Inside this rigid structure there is at least one means of detecting the input force, e.g. piezoelectric force sensors or strain gauges.

With this structure the user can then touch the manipulator, wherein, if the manipulator is e.g. in a gravitation compensated mode, the user is then able to guide the manipulator in space at will via contact with the input device, i.e. the manipulator follows the movement specified by the user.

The user guides the manipulator e.g. to the object that is to be processed or handled by the manipulator or an end effector attached to it. On contact with the object, the guiding force by the user and the counterforce resulting from the object cancel each other out, so that the user then defines or specifies an input force via the input device, which is detected accordingly by the sensors.

In the following, this input force is then amplified via the control system, taking into account the amplification parameters, to the desired value of the process force to be exerted on the object by the manipulator or end effector.

For example, a user wants to lift a heavy object, but would not be able to do so himself. He guides the manipulator to the object and then applies an input force in the sense of a lifting, whereby the manipulator then exerts an increased process force, taking into account the weight of the object, in order to lift this object, still under the guidance of the user by means of the input device, and bring it to a desired position.

Therefore, according to the invention, a user can use a robot system for arbitrary activities via the input device which is adapted and designed to cooperate with an end effector of the manipulator and further to predefine the movement of the manipulator upon contact. The object can be any object or component in a manufacturing or assembly or production process.

Also conceivable is the use of the device according to the invention in the field of medicine, e.g. when inserting prostheses, or in physiotherapy, in which the therapist applies light manual forces via the input device, which are correspondingly increased or amplified by the manipulator, whereby the therapist is still able to feel and palpate e.g. muscular hardenings via the feedback control of the sensitive manipulator.

The robot system according to the invention with the manipulator guided by a user therefore recognizes whether a force detected by the manipulator is exerted by the user or results from environmental contact. In addition, the robot system recognizes which movement as specified by the user the manipulator is to follow and, in the case of contact with an object, which increased process force is to be exerted and also in which orientation this process force is to be exerted, depending on the input force.

The input device, which is designed separately from the manipulator, can act on the manipulator at any point.

An input device that is spatially separated from the manipulator of the robot system, e.g. as a stiff glove, but which is still connected to the control system of the manipulator via known signal transmission techniques, has the advantage that a user can operate several robot systems with one single input device, some of which robot systems can be configured differently. For example, in the field of geriatric care it would be conceivable that within a defined space serving as living space several stationary robot-supported assistance systems are provided which can be operated by one and the same input device in the sense of the invention.

According to a further embodiment, however, it is also possible that the input device is fixed directly to the manipulator, preferably in the area of the end effector, and is also provided as a structure anatomically adapted to the user.

For example, it is also conceivable that an input device with corresponding sensors is placed directly on the fingers of a gripping mechanism, which are simply touched by the user, so that a user can perform simple clamping or squeezing movements under amplified process force with respect to the objects to be gripped.

In a further embodiment of the device according to the invention, it is provided that the input device is designed to be actuated by a manipulator of a further robot system, or said further manipulator has an input device which interacts with the manipulator of the executing robot system. In this way, it is possible for two robots to complement each other in a cascading manner with respect to the process force and thus implement a greater amplification of the process force.

As mentioned above, the robot systems used in the context of the invention shall preferably be compliance-controlled, i.e. impedance-, admittance- and/or torque-controlled robot systems of lightweight construction.

Such robot systems have means for sensing forces acting on the manipulator. For example, if the manipulator is designed as an articulated arm robot, torque or moment sensors may be provided at the joints of the articulated arm robot. Force-moment sensors may also be provided on the manipulator, which can detect the forces or torques acting on the manipulator by means of strain gauges. Furthermore, motor currents which occur in the drives of the manipulator can also be evaluated. The means for detecting forces thus allows the detection of external forces acting on the manipulator, which is used to realize the feedback control as intended for the invention. In yet another aspect, the present invention also relates to a method for the application of a process force to an object by a manipulator of a robot within the scope of a task to be carried out by the manipulator with respect to the object, comprising the steps
determining of an input force by a user with respect to the object;
amplifying the input force to a value of a process force by the manipulator according to a defined conversion factor;
applying the process force to the object by the manipulator;
detecting a counterforce resulting when the manipulator contacts the object; and
transmitting the counterforce to the user.

Accordingly, the counterforce is transmitted as a function of a predetermined conversion factor. Thus, for example, it can be transmitted to the user in a reduced form via the input device, quasi in the sense of a haptic feedback, if necessary supported by other audio-visual signals as a warning, which may be necessary in particular for interactions with humans.

The input force can be defined either when the input device contacts the manipulator or when the input device contacts the object directly.

It is also possible to change the amplification factor so that the process force can be dynamically varied when applied to the object. The dynamic change is user-defined via the control, e.g. via speech input in real time, which is advantageous for physiotherapeutic applications, among others. Furthermore, in the control system, at least one limit or threshold value can be directly assigned to the amplification or conversion factor or to the process force. In physiotherapeutic or surgical applications, this prevents an input force that is inadvertently exerted too strongly by the user from being correspondingly amplified by the manipulator too strongly to prevent injury. The consideration of threshold values is also an advantage in the production and assembly of filigree, fragile components.

The invention is characterized in that, for the purpose of applying a process force or process force sequence, irrespective of the intended use, a robot, preferably an articulated arm robot of lightweight construction, realizes force amplification under specification of an activity- or task-related motion and input force specified by a user or even by another robot, and the user (or the other robot) is continuously provided with direct feedback with respect to the counterforce resulting from the interaction with the objects, which basically allows the performance of sensitive activities.

In this respect, the present invention also differs substantially from known exoskeletal structures or general concepts for the amplification of human motion and related forces, all of which are mainly position-regulated or position-controlled, in which the user can only move the effectors to certain positions and only apply certain forces to these positions without feedback control.

An advantageous application of the device according to the invention is also in the field of support of elderly and disabled persons who are not able to apply the forces necessary for certain activities themselves.

Thus, according to the invention, it is intended to place a device with a manipulator on a wheelchair, with the user carrying the rigid structure of the input device. Such an arrangement proves to be much more practical than commonly known bulky exoskeletons, especially since the robot system can be activated without great effort and without a long time delay.

The device according to the invention can also be used for teaching a robot system. In principle, the teach-in procedure is used to specify the later trajectories of the robot arm or the effector by having the user simulate and store the movements by guiding the manipulator, for example in a gravitation-compensated mode. Up to now, however, the teach-in procedure has not taken into account the process forces that may have to be applied during the movements of the manipulator when it comes into contact with an object. Up to now, these forces were still entered separately via a control of a mobile handheld device or via a programming interface of a computer. The use of a device according to the invention with an input device which interacts with the manipulator now allows the user, in addition to guiding the manipulator, to demonstrate the process forces to be applied for certain tasks and to store them together in relation to the trajectories.

Further advantages and features of the present invention result from the description of the embodiments as shown in the enclosed drawings, in which

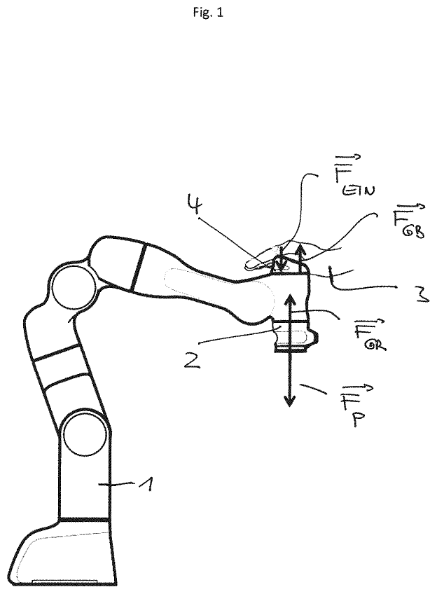

FIG. 1 shows a first embodiment according to the invention;

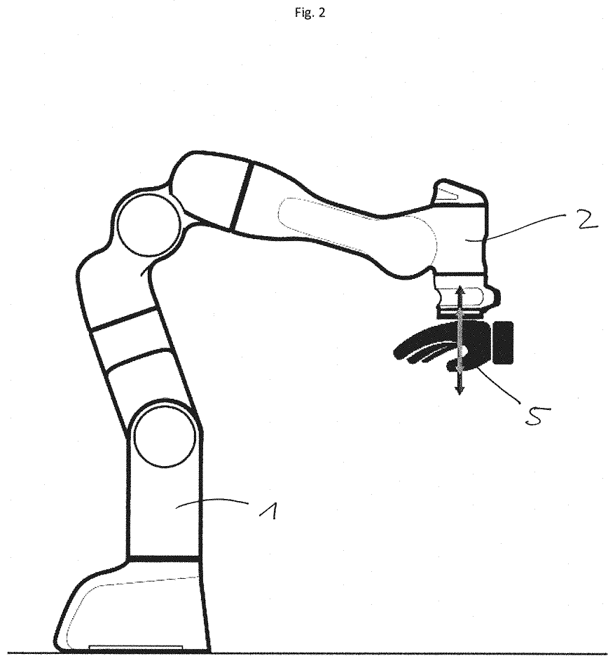

FIG. 2 shows a second embodiment according to the invention;

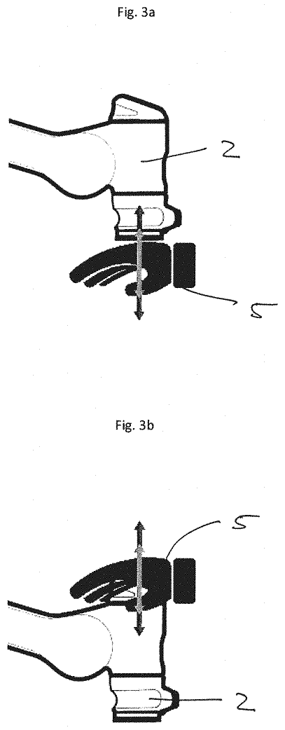

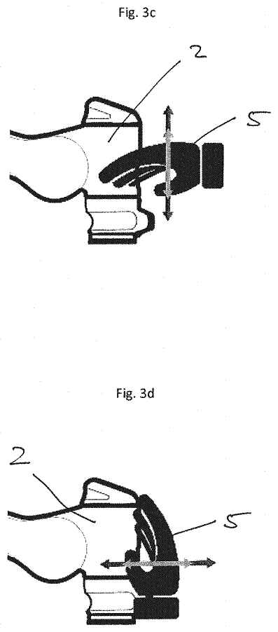

FIG. 3a-d schematically show different arrangement variants for an input device with respect to the second embodiment;

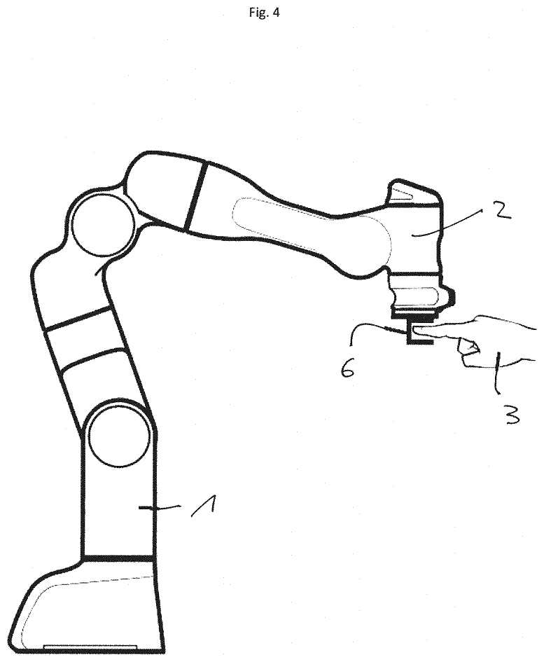

FIG. 4 shows a third embodiment according to the invention;

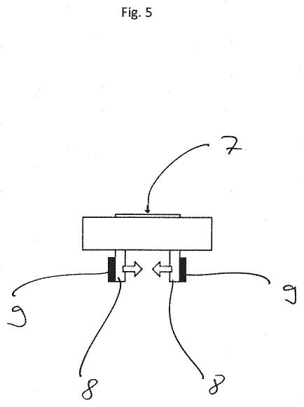

FIG. 5 shows a fourth embodiment according to the invention;

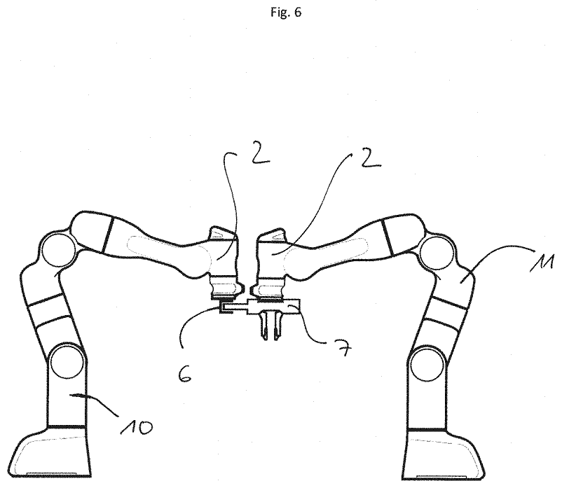

FIG. 6 shows a fifth embodiment according to the invention; and

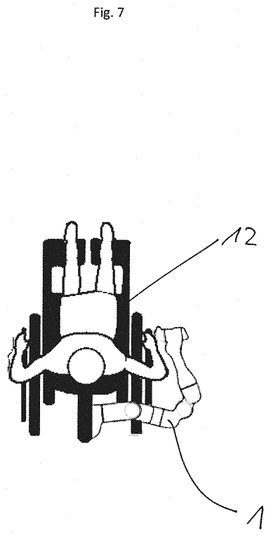

FIG. 7 shows the arrangement of a manipulator according to the invention on a wheelchair.

FIG. 1 shows a first embodiment according to the invention.

A multi-axis manipulator 1 of a robot system of lightweight construction has an end effector 2 at its distal end, with which the manipulator 1 is to interact with an object not shown here, e.g. to push it down.

The manipulator 1 can be guided arbitrarily in space according to its degrees of freedom given by the number of articulated arms by guiding contact by means of the hand 3 of a user, if the manipulator 1 is e.g. in its gravity compensated mode.

As soon as the distal end of the end effector 2 comes into contact with an object, e.g. to press it down, the user applies an input force F_{EIN} via his hand 3, which is detected by an input device 4 located at the proximal end of the end effector 2.

In a controller of the robot system, corresponding conversion factors are stored, which determine the amplification with which the input force F_{EIN} is to be converted by the manipulator 1 into an output force and then applied to the object as a process force F_{P}.

It goes without saying that on contact with the object a counterforce F_{GR} is generated in the manipulator 1 or in the end effector 2, which is measured in these elements.

In order to enable feedback control of the entire process for the user, it is now provided according to the invention that this inherent counterforce F_{GR} is mapped via a corresponding reducing conversion factor to a counterforce F_{GR}, which is transmitted to the user via his hand 3 by means of corresponding actuators or the like within the input device 4 in a haptic manner.

FIG. 2 shows a further embodiment according to the invention.

In this case, the input device 5 is designed as a rigid glove which is firmly connected, i.e. force-transmittingly, to the distal end of the end effector 2. However, as FIGS. 3a to 3d show, any arrangement of the glove 5 on the end effector 2 is conceivable, depending on how guidance and force application is to be carried out by the user.

Inside the glove 5 there is at least one sensor (not shown) to detect the input force exerted by the user as soon as the glove 5 comes into contact with an object not shown here.

First, the user can guide manipulator 1 with its end effector 2 to the object in its gravity-compensated state via the glove 5. When the glove 5 comes into contact with the object, the user then applies an increased or amplified process force, which is transmitted from the manipulator 1 to the object via the rigid structure of the glove 5. Such an arrangement is suitable, for example, for physiotherapeutic applications such as massages.

The feedback control for the presentation of a reduced counterforce is also carried out inside the glove 5, for example, via corresponding actuators. A varying counterforce can result from muscle hardening in the above example.

FIG. 4 shows a further embodiment according to the invention.

Instead of a stiff glove 5, only a thimble 6 is attached to the distal end of the end effector 2, which can serve as a force sensor in itself or can itself be designed as a stiff structure with an integrated force sensor. This arrangement is advantageous if the end effector 2, in addition to the sensor 6, carries a mechanism (e.g. a screw head) with which it interacts with the object.

Another embodiment is shown in FIG. 5. A gripping mechanism 7, which can be attached to a distal end of a manipulator 1, has two gripping fingers 8 that can be moved relative to each other. On the outer sides of the gripper fingers 8, corresponding sensors 9 are provided as input devices, so that a user can easily apply an input force by lightly pressing the sensors 8, which the gripping mechanism 7 amplifies by taking into account a gain factor when gripping an object.

FIG. 6 shows an embodiment according to the invention, in which the input device 6 of the force amplifying manipulator 10 of a robot system interacts with an end effector 7 of a manipulator of another robot system. The manipulator 11 is therefore intended to apply the corresponding process force with respect to an object, e.g. gripping, and is guided and force-amplifyingly supported by the manipulator 10, whereby the counterforces resulting from the action of the manipulator 11 are transmitted to the manipulator 10 via the input device 6, thus enabling the feedback control of the manipulator 10, wherein preferably both manipulators 10 and 11 being compliance controlled.

A particular field of application of a device according to the invention is in the field of care. It is therefore intended that a manipulator 1 according to the invention is attached to a wheelchair 12 which can be activated by the user via a corresponding input device at the end of the manipulator 1, e.g. for lifting or placing objects in the immediate vicinity of the wheelchair.

1. Robot system comprising a multi-axis manipulator for applying a process force (F_{P}) to an object with respect to a task by means of which the manipulator interacts with the object, wherein the manipulator is designed, upon contact with the object, to
detect an input force (F_{EIN}) directly exerted on the manipulator by a contact of an user,
amplify the input force (F_{EIN}) depending on a defined conversion factor to a desired value of the process force (F_{P}) in relation to the task,
detect a counterforce (F_{GR}) which is produced when the manipulator comes into contact with the object, and
transmit this counterforce (F_{GR}) to the user depending on a defined conversion factor.

2. Robot system according to claim 1, in which the manipulator is further designed to change the conversion factor for the amplification to the value of the process force (F_{P}) during the performance of the task.

3. Robot system according to claim 1, in which the conversion factor for the counterforce (F_{GB}) corresponds to the reciprocal of the conversion factor for the process force (F_{P}).

4. Robot system according to claim 1, in which the manipulator comprises at least one means for detecting the input force (F_{EIN}) by the user.

5. Robot system according to claim 1, in which the manipulator comprises at least one means for transmitting the counterforce (F_{GB}) to the user.

6. Robot system according to claim 4, in which the means are arranged at an end effector of the manipulator.

7. Robot system according to claim 1, in which the robot system is compliance-controlled.

8. Device for applying a process force (F_{P}) to an object comprising:
at least one input device configured to determine an input force (F_{EIN}) with respect to the object, the input device comprising at least one means for detecting the input force (F_{EIN}); and
a robot system with a manipulator which is designed to apply a process force (F_{P}) to the object on contact with the object and, depending on a defined conversion factor, to amplify the input force (F_{EIN}) to the value of the process force (F_{P}) during application;
wherein the manipulator is further configured to detect a counterforce (F_{GR}) which is set up when the manipulator contacts the object, and wherein the input device is configured to map this counterforce (F_{GR}) as a function of a defined conversion factor.

9. Device according to claim 8, in which the input device is formed separately from the manipulator and is designed to determine the input force (F_{EIN}) upon contact with the manipulator.

10. Device according to claim 8, in which the input device is arranged on the manipulator.

11. Device according to claim 9, in which the input device is designed to be actuated by a manipulator of another robot system.

12. Device according to claim 9, in which the input device is a structure portable and/or operable by a user.

13. Device according to claim 12, in which the structure is rigid and designed to cooperate with an end effector of the manipulator.

14. Device according to claim 8, in which the input device is further designed to determine the movement of the manipulator upon contact of the input device with the manipulator.

15. Device according to claim 8, in which the robot system is compliance-controlled.

16. A method for processing workpieces, comprising:
using the robot system according to claim 1 on an object, in which the object is a workpiece and the manipulator is designed to process the workpiece by means of an end effector.

17. A method for lifting and/or guiding and/or gripping objects, comprising:
using the robot system according to claim 1 on an object, wherein the object is an item and the manipulator is designed to lift and/or guide and/or grip the item by means of an end effector.

18. A method for manipulating human beings, comprising:
using the robot system according to claim 1 on an object, wherein the object is a human being and the manipulator is designed to process parts of the human body by means of an end effector.

19. A method, comprising:
using the robot system according to claim 1 to teach the manipulator of the robot system with respect to the motion sequence and the force profile of the task to be performed by the manipulator.

20. Wheelchair for a user comprising at least one robot system according to claim 1.

21. Method of applying a process force (F_{P}) to an object by a manipulator of a robot within the scope of a task to be performed by the manipulator with respect to the object, comprising the steps of
setting an input force (F_{EIN}) by a user with respect to the object;
amplifying the input force (F_{EIN}) to a value of a process force (F_{P}) by the manipulator according to a defined conversion factor;
applying the process force (F_{P}) to the object by the manipulator;
detecting a counterforce (F_{GR}) resulting when the manipulator contacts the object; and
transmitting the counterforce (F_{GR}) to the user.

22. Method according to claim 21, in which the transmission of the counterforce (F_{GB}) takes place according to a defined conversion factor which corresponds to a reciprocal value of the defined conversion factor with respect to the process force (F_{P}).

23. Method according to claim 21, in which the input force (F_{EIN}) is entered by the user via a contact directly on the manipulator.

24. Method according to claim 21, in which the input force (F_{EIN}) is input by the user via an input device cooperating with the manipulator.

25. Method according to claim 24, in which the counterforce (F_{GB}) is transmitted to the user by the input device.

26. Method according to claim 21, in which the defined conversion factor is variable in relation to the process force (F_{P}) so that the process force (F_{P}) is dynamically variable when applied to the object.

27. Method according to one of claim 21, in which at least one threshold value is assigned to the defined conversion factor with respect to the process force (F_{P}) or to the process force (F_{P}).

28. A method for processing workpieces, comprising:
using the device according to claim 8 on an object, in which the object is a workpiece and the manipulator is designed to process the workpiece by means of an end effector.

29. A method for lifting and/or guiding and/or gripping objects, comprising:
using the device according to claim 8 on an object, wherein the object is an item and the manipulator is designed to lift and/or guide and/or grip the item by means of an end effector.

30. A method for manipulating human beings, comprising:
using the device according to claim 8 on an object, wherein the object is a human being and the manipulator is designed to process parts of the human body by means of an end effector.

31. A method, comprising:
using the robot system according to claim 1 to teach the manipulator of the robot system with respect to the motion sequence and the force profile of the task to be performed by the manipulator.

32. Wheelchair for a user comprising at least one device according to claim 8.
